(19) United States
(12) Patent Application Publication
(10) Pub. No.: US 2003/0011734 A1
(43) Pub. Date: Jan. 16, 2003

(54) Multi-domain liquid crystal display having bump structures with non-parallel boundaries

(76) Inventors: Hong-Da Liu, Juipei City (TW); Ching-Yih Chen, Miaoli (TW); Ing-Jer Lin, Juipei City (JP); Ching-Her Chao, Juipei City (TW)

Correspondence Address: SUPREME PATENT SERVICES, POST OFFICE BOX 2339, SARATOGA, CA, 95070, US

(21) Appl. No.: 09/902,930

(22) Filed: Jul. 10, 2001

(51) Int. Cl. G02F 1/1337

(52) U.S. Cl. 349/129

(57) ABSTRACT

A multi-domain liquid crystal display has at least one wall bump structure formed on one of pixel and common electrode layers. Each wall bump structure has a plurality of boundaries and the opposite sides of the boundaries are not parallel to each other. One of the electrode layers may be formed with openings. The non-parallel boundaries of the wall bump structures cause various pre-tilted directions for the liquid crystals filling the gap between two substrates. The viewing angle of the liquid crystal display is increased and the stability of the multi-domain effect is enhanced with the wall bump structures. The liquid crystals may be aligned vertically, horizontally, tilted with an angle, or reverse tilted with an angle using a mask rubbing process or a photo aligned method. If wall bump structures are formed on both pixel and common electrode layers, they may overlap each other.

### FIELD OF THE INVENTION

The present invention relates generally to a multi-domain liquid crystal display (MD-LCD), and more specifically to a multi-domain liquid crystal display having wall bump structures of non-parallel boundaries for increasing the stability of multi-domain effect.

### BACKGROUND OF THE INVENTION

The market for liquid crystal display (LCD) panels is increasing rapidly. Because high-quality LCD panels are required for desktop monitors, wide-viewing angles and fast response time become very critical in meeting the monitors' requirements. Controlling liquid crystal domains is the most important technology in obtaining a wide-viewing angle LCD. Each pixel of a LCD is divided into multiple domains to compensate for optical asymmetry and to increase the viewing angle of the LCD. The techniques of the conventional MD-LCD can be divided into four categories. The first category uses transparent material to form protruded portions or bumps on a substrate to tilt vertically aligned liquid crystals along different directions when an electrical voltage is applied. Although this technique can pre-tilt liquid crystals without a rubbing process, the liquid crystals are not very stable when the electrical voltage is applied. It often requires other techniques to stabilize the multi-domain effect.

The second category relies on slits or openings formed on an ITO electrode layer by etching in cooperation with fringe field effect to form multiple domains similar to the first technique. In practice, the technique can be combined with the first technique to achieve better results. If the second technique is used alone, chiral dopant has to be added to the liquid crystals and the response speed is slower. The third category uses mask rubbing which is a very complicated process with low yield. The fourth category relies on a photo-aligned method that is still immature.

Forming multiple domains of the conventional multi-domain twisted nematic liquid crystal displays requires several rubbing process steps during the manufacturing. Both anti-static charge and prevention of particle contamination are issues that have to be resolved. At present, multiple illumination steps are needed in the technique of the photo-aligned method for the formation of multiple domains.

FIG. 1 shows an example of the conventional multi-domain vertically aligned liquid crystal display with bump structures. The multiple domains in the display are enhanced by means of fringe field effect and bump structures formed on both upper and lower substrates. As illustrated by the cross-sectional view in FIG. 1, the liquid crystal display 100 comprises a liquid crystal layer sandwiched between two substrates. The lower substrate 108 is a thin film transistor substrate with a pixel electrode layer 105 formed thereon. The upper substrate 109 is a color filter substrate with a common electrode layer 106 formed underneath. A pair of cross polarizers 101 and 102 are attached on the exterior surfaces of the display. Compensation films 103 and 104 are placed between the two polarizers. As can be seen from FIG. 1, a plurality of bump structures 111-117 are formed in the common and pixel electrode layers.

The conventional technique of using transparent material to form bump structures for vertically aligned multi-domain liquid crystal display has another drawback that the bump structures comprise parallel walls which result in disclination lines in the transparent areas of the display. Furthermore, bump structures have to be formed on both upper and lower substrates of the display to ensure that liquid crystals are aligned stably in the multiple domains to avoid the drifting of optical textures.

This kind of LCD has a 55% light intensity of a conventional TN LCD. It may also generate reversed disclination lines because the angle between a bump structure and a pixel electrode is 45°. Moreover, the horizontal gap between the upper and the lower bumps must be less than 30 μm. The alignment accuracy, however, may be a problem. Therefore, the design specification is not easy to meet and the process window is small.

### SUMMARY OF THE INVENTION

The present invention has been made to overcome the above-mentioned drawbacks of a conventional multi-domain liquid crystal display. The primary object is to provide a multi-domain liquid crystal display. The multi-domain liquid crystal display has wall bump structures of non-parallel boundaries formed on an electrode layer of a single substrate or on the electrode layers of two parallel upper and lower substrates. Openings or bump structures that are used in cooperation with the wall bump structures of non-parallel boundaries may also be formed on one of the electrode layers.

According to the invention, the boundaries of the wall bump structure are not parallel to each other and the width and height between two opposite sides may be different. The non-parallel boundaries make different pre-tilted directions. Therefore, the disclination lines are easily trapped in the center of a pixel area, and the stability of the multi-domain effect is increased.

In one embodiment of this invention, one of the two substrates is a substrate with thin film transistors (TFT) and the wall-bump structure is formed around a pixel area on a pixel electrode layer. In another embodiment, one of the two substrates is a color filter substrate and the wall-bump structure is formed in a pixel area on a common electrode layer. Each wall bump structure has a plurality of boundaries and the opposite sides of the boundaries are not parallel to each other. The response speed of the MD-LCD is very fast. The rise time is 9 ms and the decay time is 21 ms when an electrode voltage of 7 volts is applied.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of a conventional multi-domain vertically aligned LCD with bump structures.

FIG. 2 shows the first embodiment in which a wall bump structure of the multi-domain liquid crystal display is formed around a pixel area on a pixel electrode layer of a TFT substrate according to the invention.

FIG. 3 shows the second embodiment in which a wall bump structure of the multi-domain liquid crystal display is formed in a pixel area on a common electrode layer of a color filter substrate according to the invention.

FIG. 4 shows that the wall bump structure in FIG. 2 has eight non-parallel boundaries.

FIG. 5 shows a repeated pattern around pixel areas of the wall bump structures in FIG. 4.

FIG. 6 shows a repeated pattern in the pixel areas of the wall bump structures in FIG 3.

FIG. 7 shows that the wall bump structures on both substrates are fabricated simultaneously by combining the wall bump structures shown in FIGS. 5 and 6 according to the invention.

FIG. 8a shows the actual dimensions of a cross shaped wall bump structure on a color filter substrate according to the invention.

FIG. 8b shows the actual dimensions of a vertical slot shaped wall bump structure on a color filter substrate according to the invention.

FIG. 8c shows the actual dimensions of a T-inverse-T shaped wall bump structure on a color filter substrate according to the invention.

FIG. 8d shows the actual dimensions of a Y-inverse-Y shaped bump structure on a color filter substrate according to the invention.

FIG. 8e shows the actual dimensions of a V-inverse-V shaped wall bump structure on a color filter substrate according to the invention.

FIG. 8f shows the actual dimensions of an X shaped wall bump structure on a color filter substrate according to the invention.

FIG. 8g shows the cross-sectional view of a wall bump structure which has a convex and rounded top.

FIG. 8h shows the cross-sectional view of a wall bump structure which has a convex and rectangular top.

FIG. 9 shows that the domain boundary of the liquid crystal is trapped in the center of a pixel area according to the invention.

FIGS. 10a-10c show the light intensity contours in a pixel area of the MD-LCD of the invention when the electrical voltages of 0 volts, 4 volts, and 7 volts are applied, respectively.

FIG. 11 shows several openings formed on the pixel electrode layer and horizontal wall bump structures formed above the openings.

FIG. 12 shows that wall bump structures formed on both pixel and common electrode layers are overlapping each other.

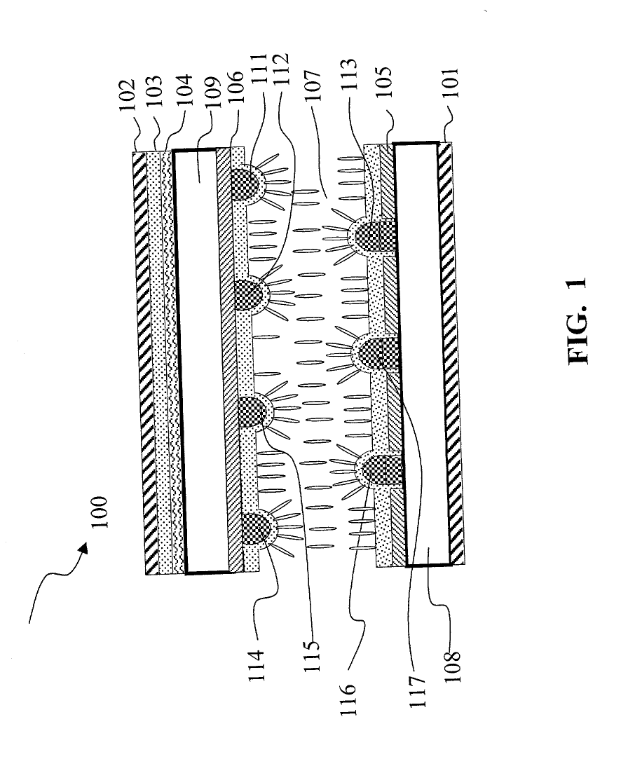

### DETAILED DESCRIPTION OF THE PREFERRED EMBODIMENTS

The primary operating principle of the MD-LCD of the invention uses the combination effect of the special wall bump structures formed on substrates and fringe field effect to form multi-domains of the liquid crystal molecules. It also relies on the special wall bump structures and their method of fabrication on the upper and lower parallel substrates to increase the stability of the multi-domain effect. According to the invention, the multi-domain liquid crystal display comprises a first substrate with a pixel electrode layer formed thereon, a second substrate with a common electrode layer formed thereon, at least one wall bump structure formed in one of the electrode layers, a liquid crystal layer with liquid crystals filling a space between the pixel and common electrode layers. Each wall bump structure has a plurality of non-parallel boundaries.

According to the invention, in an embodiment, one of the two substrates is a TFT substrate and each wall-bump structure is formed around a pixel area on the pixel electrode layer. In another embodiment, one of the two substrates is a color filter substrate and the wall-bump structure is formed in a pixel area on a common electrode layer. The liquid crystal layer may be filled with liquid crystals, liquid crystals with dye, or liquid crystals with monomer. The liquid crystals may be aligned vertically, horizontally, tilted with an angle, or reverse tilted with an angle.

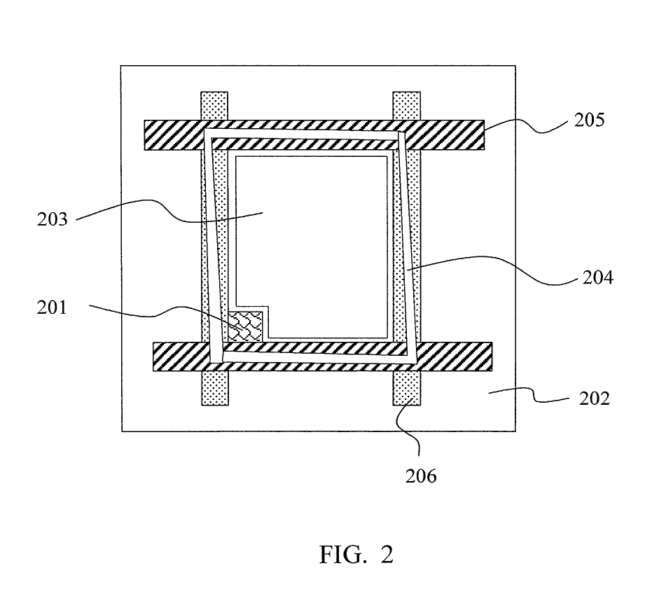

A first embodiment in which a wall bump structure of the multi-domain liquid crystal display is formed around a pixel area on a pixel electrode layer of a TFT substrate is illustrated in FIG. 2. A pixel electrode 203 and a TFT 201 are formed on a substrate 202. A wall bump structure 204 is formed around the pixel electrode 203 and is located above the gate bus line 205 and the data bus line 206. In the embodiment, the pixel electrode is an indium-tin-oxide (ITO) electrode.

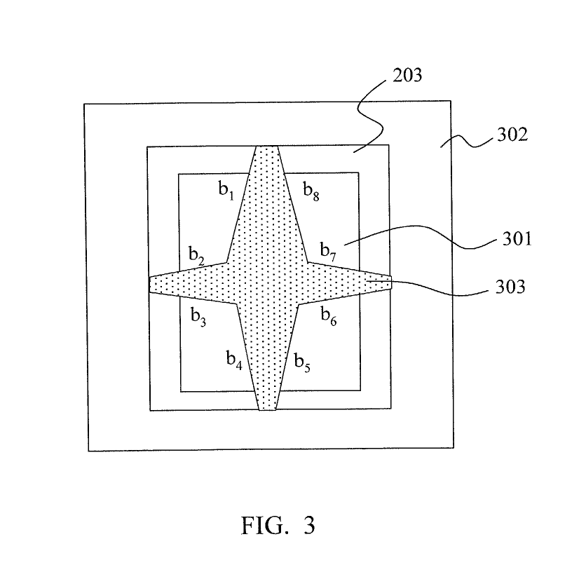

A second embodiment in which a wall bump structure of the multi-domain liquid crystal display is formed in a pixel area on a common electrode layer of a color filter substrate is illustrated in FIG. 3. A wall bump structure 303 and a color filter 301 are formed on a substrate 302. The wall bump structure 303 is located above the pixel electrode 203 and has eight non-parallel boundaries b₁ to b₈. The width and height between two opposite sides of the boundaries may be different.

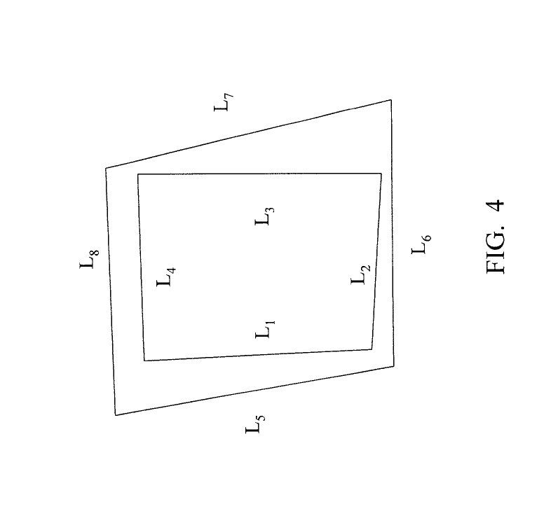

FIG. 4 shows that the wall bump structure in FIG. 2 has eight non-parallel boundaries L₁ to L₈. L₁ is not parallel to L₃, L₂ is not parallel to L₄, L₁ is not parallel to L₅, L₂ is not parallel to L₆, L₃ is not parallel to L₇, and L₄ is not parallel to L₈. Because these eight non-parallel boundaries cause different pre-tilted directions, the disclination lines are easily trapped in the center of a pixel area when an electrical voltage is applied. This increases the stability of the multi-domain effect.

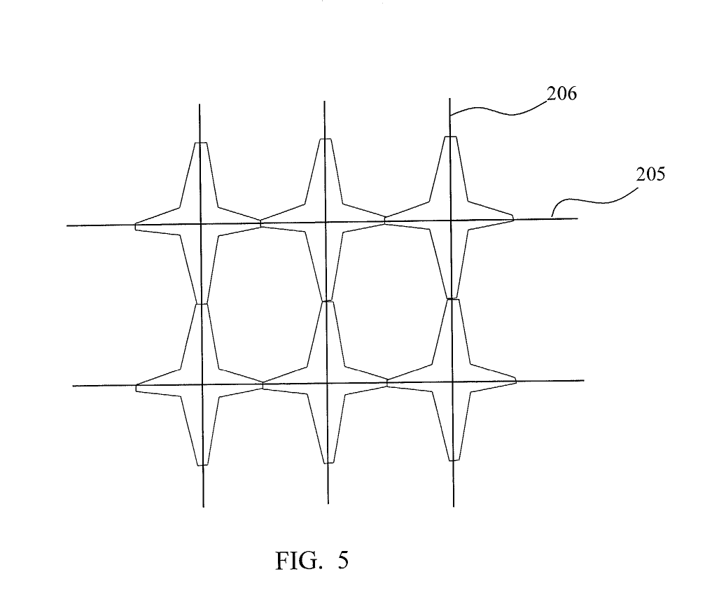

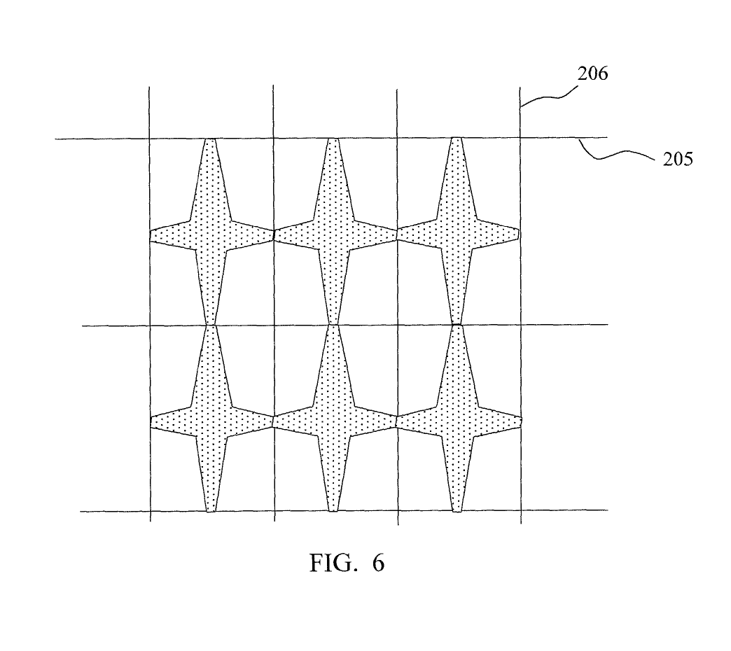

According to the invention, a pattern of the wall bump structures on the TFT substrate is formed by repeating the pattern of a single wall bump structure in FIG. 4 around all pixel areas on the TFT substrate, which is illustrated in FIG. 5. A pattern of the wall bump structures on the color filter substrate is formed by repeating the pattern of a single wall bump structure in FIG. 3 in all pixel areas on the color filter substrate, which is illustrated in FIG. 6. The wall bump structures on both substrates may be fabricated simultaneously by combining the wall bump structures shown in FIGS. 5 and 6. This is illustrated in FIG. 7.

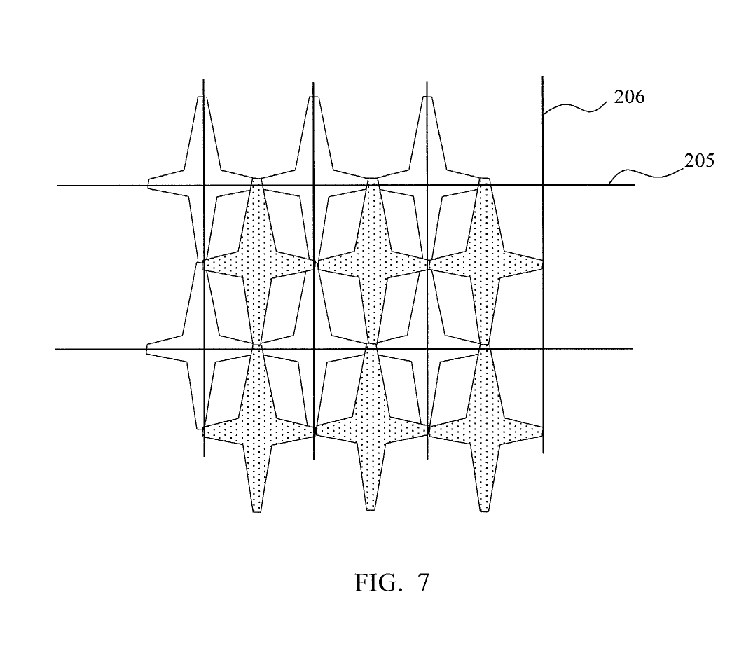

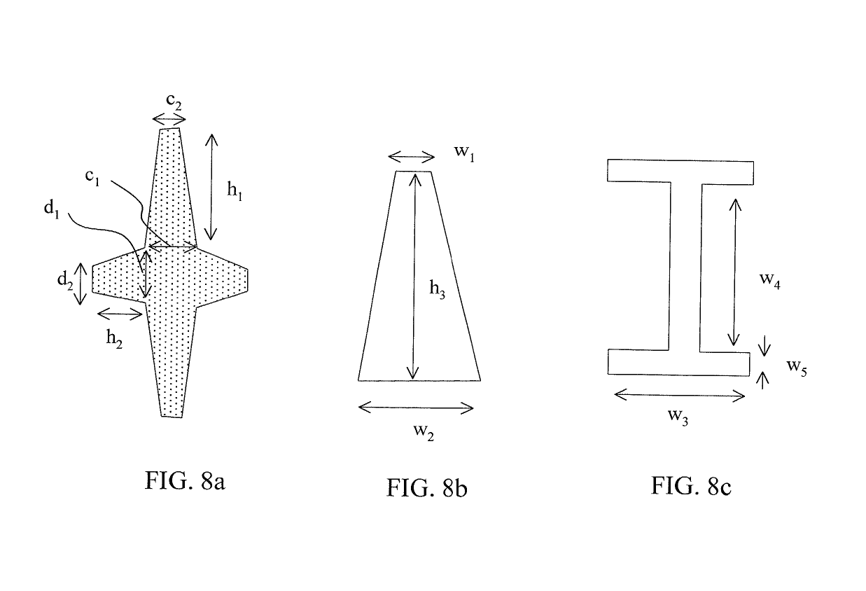

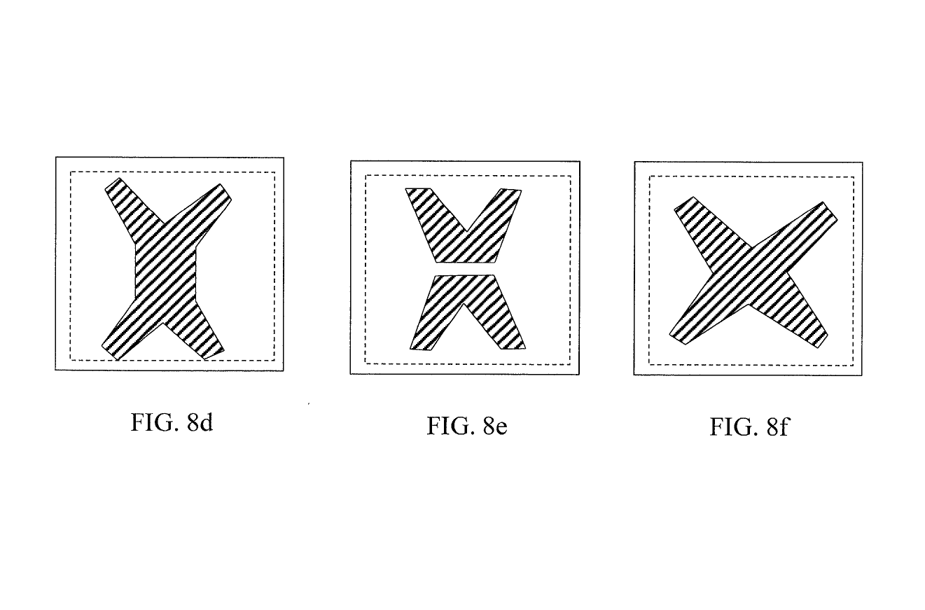

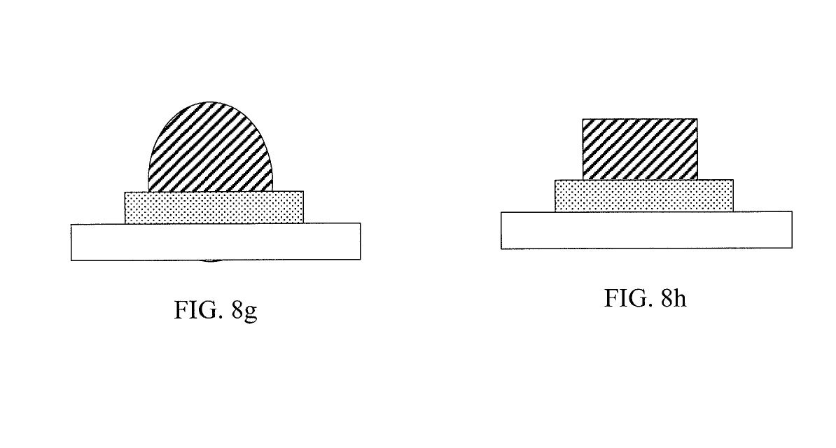

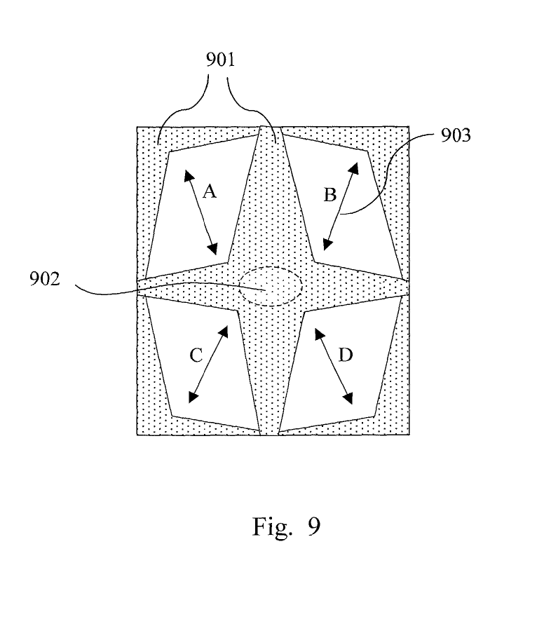

According to the invention, the top view of a wall bump structure on the color filter substrate may have different shapes. In addition to the cross shape shown in FIG. 3, it may have other shapes with different top views, such as horizontal slot, vertical slot, Y-inverse-Y, X, T-inverse-T, V-inverse-V and combinations of these shapes. FIGS. 8a-8c illustrate the actual dimensions in a pixel area for these different shapes in a preferred embodiment of the invention. FIG. 8a illustrates the actual dimensions of a cross shaped wall bump structure on a color filter substrate, where c₁=10.5 μm, c₂=3 μm, d₁=16 μm, d₂=4 μm, h₁=93.5 μm, and h₂=28.5 μm. FIG. 8b illustrates the actual dimensions of a vertical slot shaped wall bump structure on a color filter substrate, where w₁=3 μm, w₂=12 μm, and h₃=203 μm. FIG. 8c illustrates the actual dimensions of a T-inverse-T shaped wall bump structure on a color filter substrate, where w₃=56 μm, w₄=87 μm, and w₅=3 μm.

FIGS. 8d-8f illustrate other top views such as Y-inverse-Y, V-inverse-V and X shapes for bump structures. The shape of the cross-sectional side view of the wall bump structure can be convex with rounded top or convex with rectangular top as shown in FIGS. 5g-8h. The average tilted angle of a wall bump structure may range from 3° to 70°.

Because the boundaries of the wall bump structure of the invention are not parallel to each other and the width and height between two opposite sides of the boundaries are different, it is easy to form disclination point in the center of a pixel area. Therefore, the stability of the multi-domain effect is increased and the domain boundary of the liquid crystals is trapped in the center of a pixel area. As can be seen in FIG. 9, the boundaries of the wall bump structure 901 are not parallel to each other and the width and height between two opposite sides of the boundaries are different. Therefore, the stability of the multi-domain effect of the liquid crystal domains A to D is increased and the domain boundary of the liquid crystals is trapped in the center 902 of a pixel area. Also, the pretilt directions of LC 903 are fixed to avoid the drifting of optical textures.

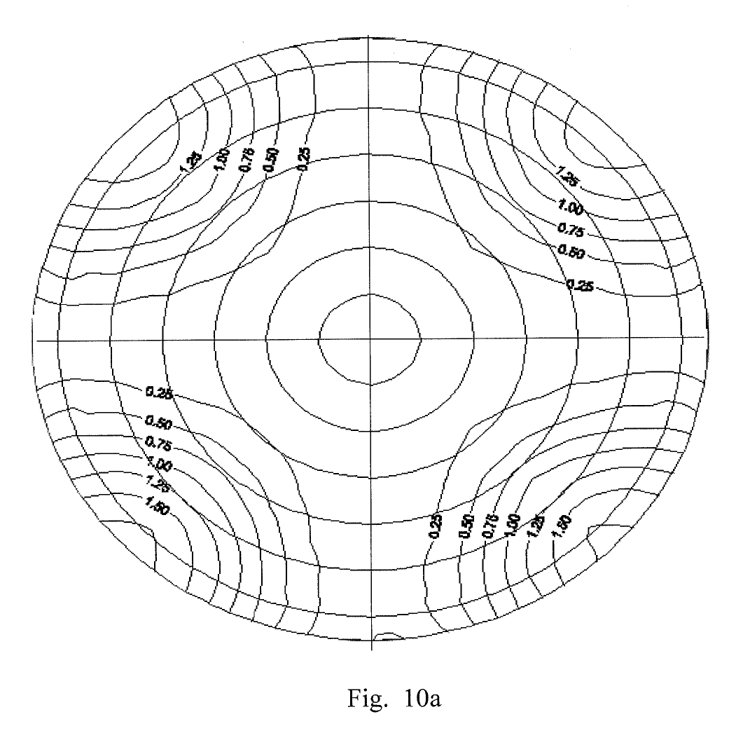

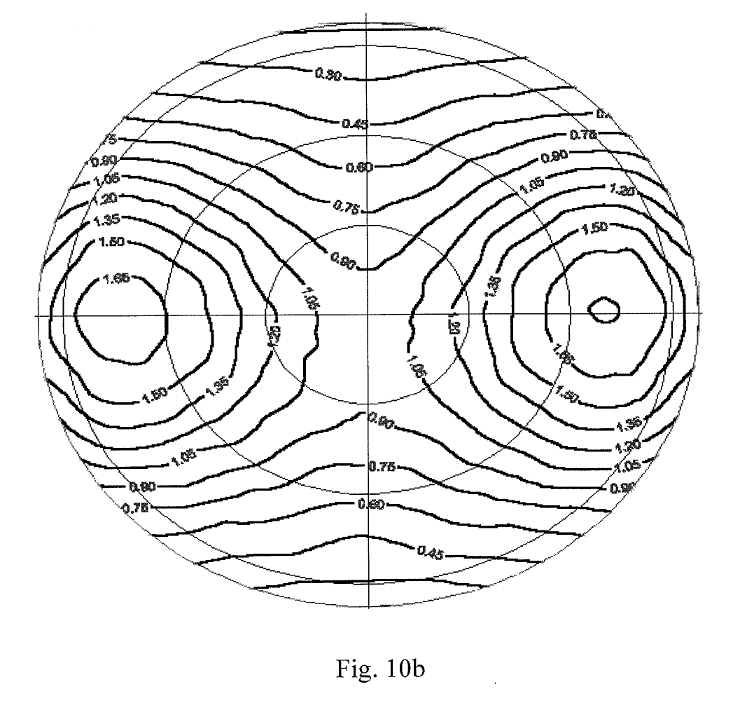

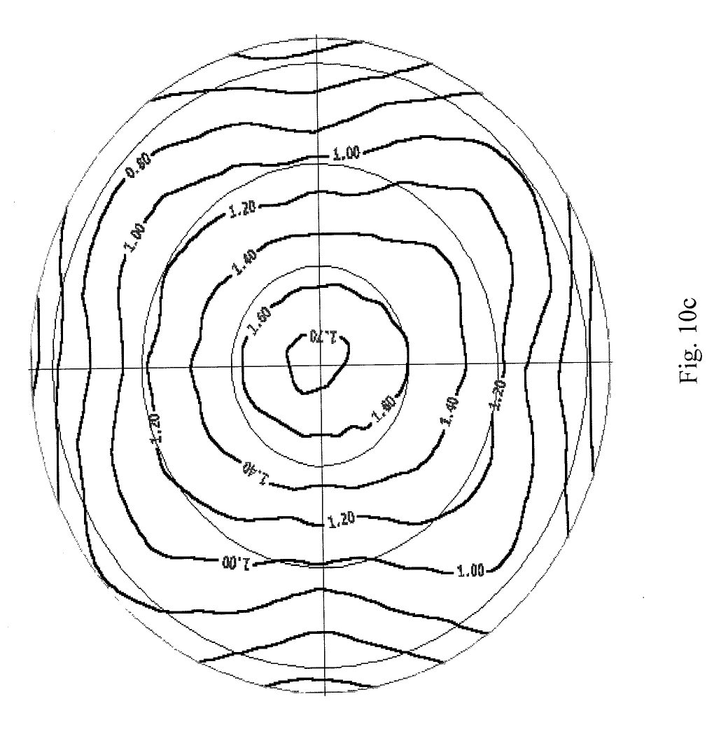

FIGS. 10a to 10c show the light intensity contours in a pixel area of the MD-LCD of the invention after the electrical voltages of 0 volts, 4 volts, and 7 volts are applied, respectively. When the electrical voltage increases from 0 volts to 4 volts and to 7 volts, the light intensity contours of the LCD get closer and symmetric to the center of the pixel area, as shown in FIGS. 10a to 10c. In other words, liquid crystal molecules form more uniform and symmetric multi-domains. Therefore, the stability of the liquid crystal domains becomes better, the viewing angle of the MD-LCD becomes wilder and the color dispersion is reduced. Note that the response speed of the MD-LCD is very fast. The rise time is 9 ms and the decay time is 21 ms after the electrical voltage of 7 volts is applied.

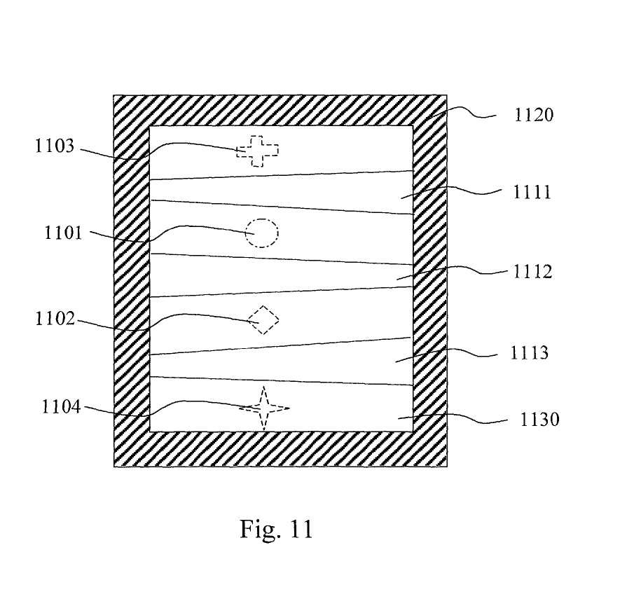

According to the invention, one or more openings may be formed on the pixel electrode layer or the common electrode layer. The wall bump structures may be formed above or below the openings as shown in FIG. 11. Openings including a circle 1101, a rhombus 1102, a cross 1103 and a star 1104 are formed on the pixel electrode layer in a pixel area 1130 of a substrate 1120. Three horizontal wall bumps 1111-1113 are formed above the openings.

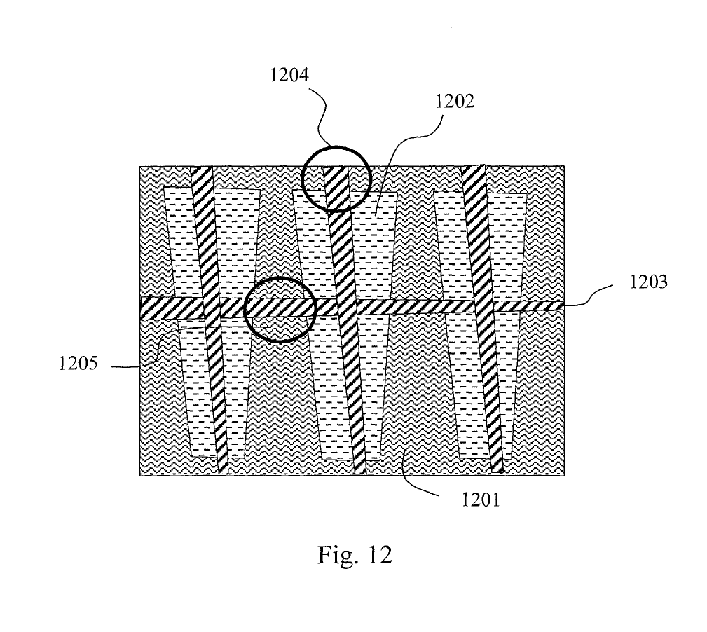

Furthermore, in the present invention every wall bump below the common electrode can be overlapped with the top of the wall bump structure that is above an opening of or around a pixel electrode as illustrated in FIG. 12. The overlapped wall bump structures include surrounding wall bump structures 1201 formed on a lower substrate around pixel areas 1202. Bump structures 1203 are formed at the central portions of pixel areas on an upper substrate. As can be seen, the bump structures 1201 and 1203 overlap each other in regions 1204 and 1205.

Moreover, like wall bump structures, openings may have different shapes. The liquid crystals may be aligned vertically, horizontally, tilted with an angle, or reverse tilted with an angle. Various aligned techniques, such as mask rubbing process or photo aligned method, can be used to align the liquid crystals for the display.

Although this invention has been described with a certain degree of particularity, it is to be understood that the present disclosure has been made by way of preferred embodiments only and that numerous changes in the detailed construction and combination as well as arrangement of parts may be restored to without departing from the spirit and scope of the invention as hereinafter set forth.

What is claimed is:

1. A multi-domain liquid crystal display, comprising:
a first substrate with a pixel electrode layer formed and a plurality of pixel area defined thereon;
at least one wall bump structure formed on said pixel electrode layer around each pixel area, each wall bump structure having a plurality of non-parallel boundaries;
a second substrate with a common electrode layer formed below said second substrate; and
a liquid crystal layer filled with liquid crystals between said pixel and common electrode layers.

2. The multi-domain liquid crystal display as claimed in claim 1, wherein at least one opening is formed on one of said pixel and common electrode layers in each pixel area.

3. The multi-domain liquid crystal display as claimed in claim 1, wherein said liquid crystal layer is filled with liquid crystals with dye.

4. The multi-domain liquid crystal display as claimed in claim 1, wherein said liquid crystal layer is filled with liquid crystals with monomer.

5. The multi-domain liquid crystal display as claimed in claim 1, wherein said liquid crystals are vertically aligned.

6. The multi-domain liquid crystal display as claimed in claim 1, wherein said liquid crystals are horizontally aligned.

7. The multi-domain liquid crystal display as claimed in claim 1, wherein said liquid crystals are tilted with an angle.

8. The multi-domain liquid crystal display as claimed in claim 1, wherein said liquid crystals are reverse tilted with an angle.

9. The multi-domain liquid crystal display as claimed in claim 1, wherein said at least one wall bump structure has a top view with a shape selected from the group of a cross, a horizontal slot, a vertical slot, a Y-inverse-Y shape, a T-inverse-T shape and a V-inverse-V shape.

10. The multi-domain liquid crystal display as claimed in claim 1, wherein said at least one wall bump structure has a convex with rounded top cross section.

11. The multi-domain liquid crystal display as claimed in claim 1, wherein said at least one wall bump structure has a convex with rectangular top cross section.

12. The multi-domain liquid crystal display as claimed in claim 1, wherein said at least one wall bump structure has an average titled angle ranging from 3 to 70 degrees.

13. A multi-domain liquid crystal display comprising:
a first substrate with a pixel electrode layer formed and a plurality of pixel area defined thereon;
a second substrate with a common electrode layer formed below said second substrate;
at least one wall bump structure formed on said common electrode layer in each pixel area, each wall bump structure having a plurality of non-parallel boundaries; and
a liquid crystal layer filled with liquid crystals between said pixel and common electrode layers.

14. The multi-domain liquid crystal display as claimed in claim 13, wherein at least one opening is formed on one of said pixel and common electrode layers in each pixel area.

15. The multi-domain liquid crystal display as claimed in claim 13, wherein said liquid crystal layer is filled with liquid crystals with dye.

16. The multi-domain liquid crystal display as claimed in claim 13, wherein said liquid crystal layer is filled with liquid crystals with monomer.

17. The multi-domain liquid crystal display as claimed in claim 13, wherein said liquid crystals are vertically aligned.

18. The multi-domain liquid crystal display as claimed in claim 13, wherein said liquid crystals are horizontally aligned.

19. The multi-domain liquid crystal display as claimed in claim 13, wherein said liquid crystals are tilted with an angle.

20. The multi-domain liquid crystal display as claimed in claim 13, wherein said liquid crystals are reverse tilted with an angle.

21. The multi-domain liquid crystal display as claimed in claim 13, wherein said at least one wall bump structure has a top view with a shape selected from the group of a cross, a horizontal slot, a vertical slot, a Y-inverse-Y shape, a T-inverse-T shape and a V-inverse-V shape.

22. The multi-domain liquid crystal display as claimed in claim 13, wherein said at least one wall bump structure has a convex with rounded top cross section.

23. The multi-domain liquid crystal display as claimed in claim 13, wherein said at least one wall bump structure has a convex with rectangular top cross section.

24. The multi-domain liquid crystal display as claimed in claim 13, wherein said at least one wall bump structure has an average titled angle ranging from 3 to 70 degrees.

25. A multi-domain liquid crystal display comprising:
a first substrate with a pixel electrode layer formed and a plurality of pixel area defined thereon;
at least one lower wall bump structure formed on said pixel electrode layer around each pixel area, each lower wall bump structure having a plurality of non-parallel boundaries;
a second substrate with a common electrode layer formed below said second substrate;
at least one upper wall bump structure formed on said common electrode layer in each pixel area, each upper wall bump structure having a plurality of non-parallel boundaries; and
a liquid crystal layer filled with liquid crystals between said pixel and common electrode layers.

26. The multi-domain liquid crystal display as claimed in claim 25, wherein at least one opening is formed on one of said pixel and common electrode layers in each pixel area.

27. The multi-domain liquid crystal display as claimed in claim 26, wherein said at least one upper wall bump structure on said common electrode layer and said at least one lower wall bump structure on said pixel electrode layer have at least an overlapped area.
